(19) United States
(12) Patent Application Publication
(10) Pub. No.: US 2021/0018047 A1
(43) Pub. Date: Jan. 21, 2021

(54) CONSTANT VELOCITY UNIVERSAL JOINT BOOT

(71) Applicant: FUKOKU CO., LTD., Saitama (JP)

(72) Inventors: Yuzo ONO, Saitama (JP); Kenji NOBUSUE, Saitama (JP)

(73) Assignee: FUKOKU CO., LTD., Saitama (JP)

(21) Appl. No.: 16/980,108

(22) PCT Filed: Feb. 15, 2019
(86) PCT No.: PCT/JP2019/005549

§ 371 Date: Sep. 11, 2020

(30) Foreign Application Priority Data
Mar. 14, 2018 (JP) 2018-047129

(51) Int. Cl. F16D 3/84; F16D 3/202

(52) U.S. Cl. CPC F16D 3/843; F16D 3/202

(57) ABSTRACT

An object is to provide a constant velocity universal joint boot that can improve resistance to fatigue failure and achieve further extension of service life even if a constant velocity universal joint swings at a large operating angle. To achieve this object, a constant velocity universal joint boot is adopted, in which a large-diameter annular portion mounted on a mating member whose outer circumferential surface is formed into a non-circular shape, and at least a part of the inner circumferential surface of the large-diameter annular portion formed into a non-circular shape, and the large-diameter annular portion, a boot bellows portion, and a small-diameter annular portion attached to a shaft are integrated, and an annular recess is provided in that part of the inner circumferential surface of the large-diameter annular portion which is adjacent to the bellows.

### TECHNICAL FIELD

The present invention relates to a constant velocity universal joint boot used for a drive shaft and the like of an automobile. More particularly, the present invention relates to a constant velocity universal joint boot fitted around an outer circumference of a constant velocity universal joint having a structure such as a tripod joint provided with plural groove-shaped recesses along an axial direction on an outer circumferential surface.

### BACKGROUND ART

Conventionally, in various fields such as automobiles, constant velocity universal joints are used that couple together two shafts—an input drive shaft and output drive shaft—such that the two shafts transmit torque by rotating at equal velocity even if there is an angular difference between the two shafts. In the case of an automobile, constant velocity universal joints are used on opposite ends of the drive shafts and grease is enclosed to lubricate the constant velocity universal joints, and “constant velocity universal joint boots” adapted to cover bends of the constant velocity universal joints are used to prevent intrusion of foreign matter such as dust and water from outside.

The constant velocity universal joint boot has a large-diameter annular portion on one end, and a small-diameter annular portion on another end. Then, the constant velocity universal joint boot is configured such that the large-diameter annular portion is fixed by being fastened by a boot band to an outer circumferential surface of an outer case (casing) of the constant velocity universal joint on a hub side while the small-diameter annular portion is fixed by being fastened by a boot band to a differential gear side. Of the constant velocity universal joints, a so-called tripod joint having plural axially slidable groove-shaped recesses on an outer circumferential surface with a roller bearing placed around a shaft portion of the drive shaft is generally used as a constant velocity joint used on the differential gear side.

If the tripod joint described above is used, when the tripod joint swings with an operating angle provided (by deforming an angle), the constant velocity universal joint boot deforms and is subjected to stresses of repeated deformation. In particular, with increases in the operating angle of the tripod joint, excessive bending stress will occur around a connection with the outer case, increasing the chances for the constant velocity universal joint boot to get damaged. Also, the tripod joint is subject not only to angular displacement, but also to axial displacement involving sliding. Thus, with the constant velocity universal joint boot fitted around the tripod joint, bending stress is applied more strongly around a connection with the outer case than a fixed constant velocity universal joint that permits only angular displacement. Therefore, the constant velocity universal joint boot fitted around the tripod joint is susceptible to cracks, wear damage, and the like when used for an extended period of time. Regarding constant velocity universal joint boots (tripod joint boots) attempting to solve this problem, there are related techniques shown below.

Patent Literature 1 discloses a tripod joint boot that downsizes the boot and provides a large swing angle to the tripod joint. For the purpose of improving durability, the tripod joint boot disclosed in Patent Literature 1 is configured such that plural thick portions provided on an inner circumference of an end portion on a large-diameter side of the boot are formed by projecting from a tapered surface extending from a small-diameter portion nearest to the end portion on the large-diameter side toward the end portion on the large-diameter side in a bellows portion.

Also, Patent Literature 2 discloses a method for producing the tripod joint boot disclosed in Patent Literature 1. The method for producing the tripod joint boot disclosed in Patent Literature 2 allows the boot to be pulled out easily from a mold in an inner circumferential portion of the end portion on the large-diameter side formed as a primary molding even if an undercut portion is provided on the tapered surface extending from the small-diameter portion nearest to the end portion on the large-diameter side of the bellows portion of a secondary molding having a thick portion toward the end portion on the large-diameter side.

### CITATION LIST

### Patent Literature

[Patent Literature 1]

Japanese Unexamined Patent Application Publication No. JP2006-17277A

[Patent Literature 2]

Japanese Unexamined Patent Application Publication No. JP2005-98487A

### SUMMARY OF INVENTION

### Technical Problem

However, there are demands that recent tripod joint boots flexibly follow widening of the operating angle of the tripod joint and achieve weight reduction. To meet these demands, it is conceivable to take measures such as “increasing the number of crests and bottoms of bellows” of the boot or “increasing the outside diameter of the bellows” while maintaining the basic configuration of the boot disclosed in Patent Literature 1 and Patent Literature 2. However, there is a problem in that these measures cannot achieve reduction of production costs, size and weight reduction of the boot, and the like that lie at the foundation of the market demands.

An object of the present invention is to provide a constant velocity universal joint boot that can follow a constant velocity universal joint even if the joint swings at a large operating angle, further reduce the size and weight, improve fatigue damage resistance, and prolong the service life.

### Solution to Problem

The inventors of the present invention have conducted earnest studies and solved the above problem by adopting a constant velocity universal joint boot described below.

In a constant velocity universal joint boot according to the present invention, a large-diameter annular portion mounted on a mating member whose outer circumferential surface is formed into a non-circular shape, and at least a part of the inner circumferential surface of the large-diameter annular portion formed into a non-circular shape, and the large-diameter annular portion, a boot bellows portion, and a small-diameter annular portion attached to a shaft are integrated, and an annular recess is provided in that part of the inner circumferential surface of the large-diameter annular portion which is adjacent to the bellows.

In the constant velocity universal joint boot according to the present invention, preferably the large-diameter annular portion includes a boot band-free zone and a boot band-attaching zone in sequence starting from a bellows side, the boot band-free zone being not fastened and fixed by a boot band, the boot band-attaching zone being fastened and fixed by a boot band; and an annular thick-walled portion is provided on at least a part of the inner circumferential surface of the large-diameter annular portion corresponding to the boot band-attaching zone, and an annular recess portion is provided on the large-diameter annular portion inner circumferential surface of the boot band band-free zone.

In the constant velocity universal joint boot according to the present invention, preferably the annular thick-walled portion provided on the inner circumferential surface of the large-diameter annular portion corresponding to the boot band-attaching zone includes a primary molded member made up of the small-diameter annular portion, the bellows, and the large-diameter annular portion molded integrally, and a secondary molded member provided only on the inner circumferential surface of the large-diameter annular portion of the primary molded member.

In the constant velocity universal joint boot according to the present application, preferably a thickness (t1) of the annular thick-walled portion provided on the inner circumferential surface of the large-diameter annular portion corresponding to the boot band-free zone is larger than a thickness (t2) of that bottom of the bellows which is closest to the boot band-free zone, and is two times or less the thickness (t2) of the bottom.

In the constant velocity universal joint boot according to the present invention, preferably the annular thick-walled portion provided on the inner circumferential surface of the large-diameter annular portion corresponding to the boot band-attaching zone has a fine annular protrusion on a surface thereof.

The constant velocity universal joint boot according to the present invention is suitably applied when the constant velocity universal joint is a tripod joint.

### Advantageous Effects of Invention

The constant velocity universal joint boot according to the present invention is made up of the small-diameter annular portion, bellows, and large-diameter annular portion, which are integrated with each other sequentially in series, and is provided with the annular recess in that part of the inner circumferential surface of the boot band-free zone which is adjacent to the bellows. Consequently, the constant velocity universal joint boot according to the present invention is subject to lower deformation stress of the bellows changing with swinging of the constant velocity universal joint than conventional constant velocity universal joint boots and has excellent flexibility. Thus, the constant velocity universal joint boot according to the present invention can follow the constant velocity universal joint even if the constant velocity universal joint swings at a larger operating angle than ever before. Furthermore, being small and lightweight and capable of exhibiting high resistance to fatigue failure, the constant velocity universal joint boot according to the present invention can achieve longer service life.

### BRIEF DESCRIPTION OF DRAWINGS

FIG. 1 is a perspective view of a constant velocity universal joint boot (tripod joint boot) according to the present invention.

FIG. 2 is a schematic sectional view taken along line A-A′ of FIG. 1.

FIG. 3 FIGS. 3(a) and 3(b) are enlarged schematic diagrams of principal part (region C and region D) in FIG. 2.

FIG. 4 is a schematic sectional view taken along line B-B′ of FIG. 1.

FIG. 5 is a schematic sectional view in which a conventional boot is bent at an angle θ.

FIG. 6 is a schematic sectional view in which the boot according to the present invention is bent at an angle θ.

FIG. 7 FIGS. 7(a) and 7(b) are schematic diagrams of a method for molding the boot according to the present invention.

FIG. 8 FIGS. 8(a) and 8(b) are schematic diagrams of mold placement for principal part (region E and region F in FIG. 7(b)) of a secondary molding of the boot according to the present invention.

FIG. 9 is a schematic sectional view of the conventional boot.

FIG. 10 FIGS. 10(a) and 10(b) are schematic diagrams of mold placement for principal part (region E and region F in FIG. 7(b)) of a secondary molding of the conventional boot.

FIG. 11 compares results of non-linear stress analysis between a boot according to an example and a boot according to a comparative example.

### DESCRIPTION OF EMBODIMENT

A constant velocity universal joint boot according to the present invention will be described below by assuming that the boot is applied to a tripod joint of a four-wheeled automobile. Also, although an embodiment of the present invention will be described in detail below with reference to the drawings, the present invention is not to be interpreted as being limited thereto. Note that it is sufficient that the constant velocity universal joint to which the constant velocity universal joint boot according to the present invention is applied has plural groove-shaped recesses on an outer circumferential surface thereof, and there is no restriction on the number and shape of the groove-shaped recesses.

A. Form of the Constant Velocity Universal Joint Boot According to the Present Invention

The constant velocity universal joint boot according to the present invention is used for a constant velocity universal joint that includes an outer case and a shaft extending from the outer case. Here, the “constant velocity universal joint” includes plural recessed grooves arranged on an outer circumference of the outer case at equal intervals along an axial direction of the shaft, where a vertical section of the outer case with respect to the axial direction of the shaft assumes a non-circular shape. A typical example of the constant velocity universal joint is a so-called tripod joint.

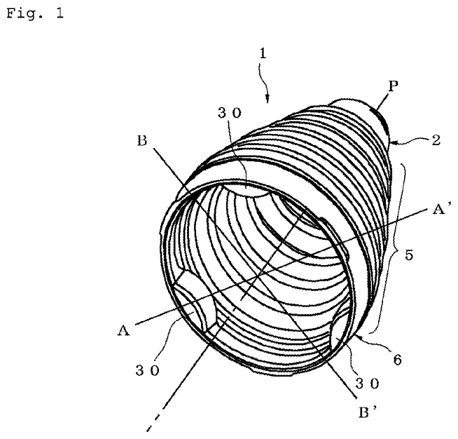

The constant velocity universal joint boot according to the present invention is formed by integrating a large-diameter annular portion attached to the outer case of the constant velocity universal joint, bellows, and a small-diameter annular portion attached to the shaft and is provided with an annular recess in that part of the inner circumferential surface of the large-diameter annular portion which is adjacent to the bellows. Here, FIG. 1 shows a perspective view of a tripod joint boot as an example of the constant velocity universal joint boot 1 according to the present invention (hereinafter also referred to as the “boot 1”) when viewed from the side of the large-diameter annular portion 6 of the boot 1. As shown in FIG. 1, the constant velocity universal joint boot 1 according to the present invention is formed by integrating the large-diameter annular portion 6 attached to the outer case of the constant velocity universal joint, bellows 5, and small-diameter annular portion 2 attached to the shaft. Also, the inner circumferential surface of the large-diameter annular portion 6 shown in FIG. 1 is provided with “projections 30” to be fitted in the plural recessed grooves in an outer circumference of the outer case of the constant velocity universal joint.

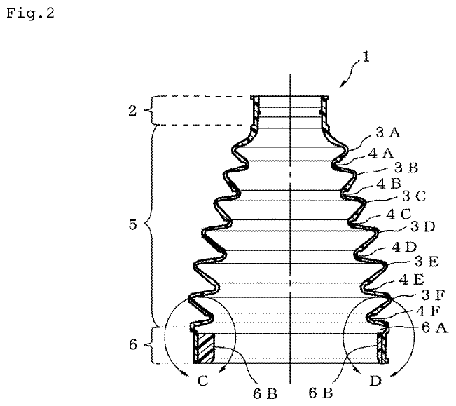

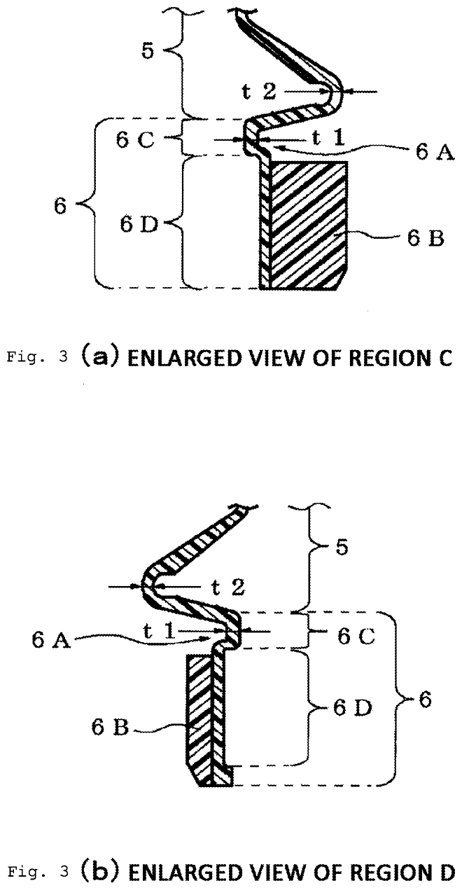

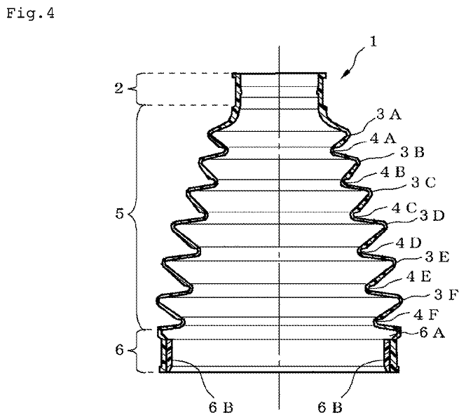

FIG. 2 is a sectional view of the constant velocity universal joint boot 1 shown in FIG. 1 taken along line A-A′ of FIG. 1 in the axial direction P of the shaft. FIG. 3(a) shows an enlarged view of region C in FIG. 2. FIG. 3(b) shows an enlarged view of region D in FIG. 2. As shown in FIG. 3(a), region C of the boot 1 has an increased thickness due to the presence of the projections 30 (see FIG. 1) on the inner circumferential surface of the large-diameter annular portion 6. On the other hand, as shown in FIG. 3(b), region D of the boot 1 without any projection 30 on the inner circumferential surface of the large-diameter annular portion 6 has a reduced thickness. Here, the annular thick-walled portion is 6B (drawing number) shown in FIG. 3(a) and FIG. 3(b). Note that FIG. 4 is a sectional view taken along line B-B′ of FIG. 1 in the axial direction P of the shaft by avoiding the projections 30.

As shown in FIGS. 2 to 4, the constant velocity universal joint boot 1 according to the present invention is provided with an annular recess 6A in that part of the inner circumferential surface of the large-diameter annular portion 6 which is adjacent to the bellows 5. The presence of the annular recess 6A dramatically increases flexibility of the boot 1 when the bellows 5 deform by bending. Note that an “input drive shaft” and “output drive shaft” existing when the boot 1 are fitted around the tripod joint can be understood technically by those skilled in the art based on common sense, and thus illustration thereof is omitted. Technical effects of the present invention will be described in detail below.

As shown in FIG. 3(a) and FIG. 3(b), in the constant velocity universal joint boot 1 according to the present invention, the large-diameter annular portion 6 includes a boot band-free zone 6C and a boot band-attaching zone 6D in sequence starting from the side of the bellows 5, where the boot band-free zone 6C is not fastened and fixed by a boot band while the boot band-attaching zone 6D is fastened and fixed by a boot band. Furthermore, the large-diameter annular portion 6 has the annular thick-walled portion 6B out of contact with the bellows 5, on an inner circumferential surface of the boot band-attaching zone 6D and has the annular recess 6A in an inner circumferential surface of the boot band-free zone 6C. The boot 1 will be described below by being divided into the “large-diameter annular portion,” “small-diameter annular portion,” and “bellows.”

(1) Large-Diameter Annular Portion

The large-diameter annular portion 6 of the constant velocity universal joint boot 1 according to the present invention includes “the boot band-free zone not fastened and fixed by a boot band (see reference sign 6C shown in FIG. 3)” and “the boot band-attaching zone fastened and fixed by a boot band (see reference sign 6D shown in FIG. 3)” in sequence starting from the side of the bellows 5. The constant velocity universal joint boot 1 according to the present invention is most greatly characterized by an internal geometry of the large-diameter annular portion 6 described below. To ensure sealing, the large-diameter annular portion 6 has an inner circumferential surface that conforms to a surface geometry of a counterpart to which the large-diameter annular portion 6 is fixed by being fitted therearound. Generally, an annular shape is adopted to allow the large-diameter annular portion 6 to be fixed by being fitted around the outer case of the constant velocity universal joint boot. Note that when an outer circumferential shape of the outer case has a concavo-convex pattern in a circumferential direction as with a tripod joint, an inner circumferential shape of the large-diameter annular portion 6 is configured to be non-circular to accommodate the outer circumferential shape of the outer case (see FIG. 1).

The boot band-attaching zone 6D will be described using FIG. 3. The boot band-attaching zone 6D is located on outer circumferential part of the large-diameter annular portion 6 and used to place a band for use to fasten and fix the large-diameter annular portion 6 to the outer case of the constant velocity universal joint. As the “boot band-attaching zone 6D” is fastened and fixed by a band, the constant velocity universal joint boot 1 according to the present invention prevents grease enclosed in the constant velocity universal joint from leaking out between the large-diameter annular portion 6 and outer case. Also, since the annular thick-walled portion 6B, which is out of contact with the bellows 5, is provided on the inner circumferential surface of the boot band-attaching zone 6D, the annular recess 6A can be installed easily in that part of an inner circumference of the after-mentioned boot band-free zone 6C which is adjacent to the bellows 5.

Preferably the annular thick-walled portion 6B provided on the inner circumferential surface of the boot band-attaching zone 6D has a fine annular protrusion (not shown) on surfaces thereof. A reason for this is that a boot band, when attached to the boot band-attaching zone 6D, increases sealing between the large-diameter annular portion 6 and outer case. Therefore, preferably plural fine annular protrusions are provided. Also, preferably height of the fine annular protrusion in a cross section in the axial direction (direction P shown in FIG. 1) of the large-diameter annular portion 6 is 0.2 mm to 1.0 mm. Here, the height of the fine annular protrusion smaller than 0.2 mm or larger than 1.0 mm is undesirable because then it is difficult to increase the sealing between the boot 1 and outer case sufficiently when the boot band is attached to the boot band-attaching zone 6D.

Next, the boot band-free zone 6C will be described using FIG. 3. The boot band-free zone 6C is a “zone not fastened and fixed by the boot band” existing adjacent to the bellows 5 by being located between the above-mentioned boot band-attaching zone 6D and the bellows 5. In so doing, in an inner circumferential surface of the boot band-free zone 6C, the boot 1 is provided with the annular recess 6A adjacent to the bellows 5. The annular recess 6A also includes a “portion not provided with the annular thick-walled portion 6B” existing in the boot band-attaching zone 6D. That is, as shown in FIG. 3(a) and FIG. 3(b), the annular recess 6A may be formed by straddling across part of the boot band-attaching zone 6D (=with the Annular thick-walled portion 6B existing only in part of the boot band-attaching zone 6D). In short, it is sufficient that the constant velocity universal joint boot 1 according to the present invention is free of the Annular thick-walled portion 6B in at least the boot band-free zone 6C and there is no particular restriction in terms the shape of the annular recess 6A. In addition, as shown in FIG. 3(a) and FIG. 3(b), the boot band-free zone 6C has a step on a boundary with the boot band-attaching zone 6D (a slight projection on the left side in FIG. 3(a) and on the right side in FIG. 3(b)), and the step is used for positioning in attaching the boot band to the boot 1. Therefore, if another means of positioning is available in attaching the boot band to the boot 1, there is no need to provide a step in a boundary area between the boot band-free zone 6C and boot band-attaching zone 6D. Also, depth of the annular recess 6A varies with the thickness of the boot band-free zone 6C in the boot 1 and with the height of the step in the boot band positioning boundary area (a boundary portion between reference sign 6C and reference sign 6D in FIG. 3(a) or FIG. 3(b)), and is also varied by designing the thickness of the annular thick-walled portion 6B existing in the boot band-attaching zone 6D to be sufficiently deep.

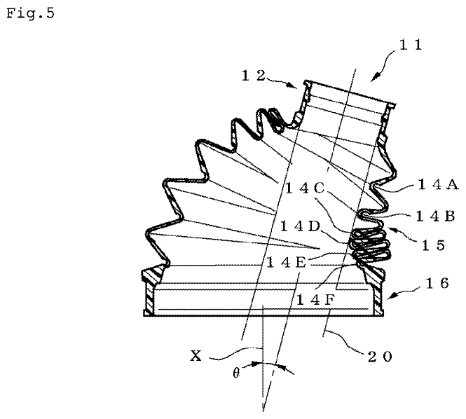

In this way, with the annular recess 6A being provided on the large-diameter annular portion 6, the constant velocity universal joint boot 1 according to the present invention allows the bellows 5 to display a bellows function sufficiently up to near a boundary with the large-diameter annular portion 6 without increasing the numbers of crests and bottoms of the bellows 5. Generally, a coupling such as a tripod joint is placed in an outer case adapted to fix the large-diameter annular portion 6 by fitting around it. Therefore, in the case of a conventional tripod joint boot 11, when the tripod joint swings, a critical point is located in that part of bellows 15 which is slightly closer to a large-diameter annular portion 16 as shown in FIG. 5. Then, near the critical point of the tripod joint boot 11, compressive stress and tensile stress are repeated alternately due to complicated operation of the tripod joint. Consequently, the tripod joint boot 11 is prone to breakage due to concentration of relatively high stresses on that part of the bellows 15 which is on the side of the large-diameter annular portion 16.

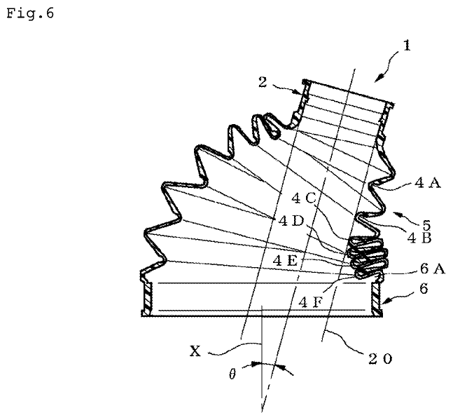

In contrast, as shown in FIG. 6, the constant velocity universal joint boot 1 according to the present invention has the annular thick-walled portion (see reference sign 6B shown in FIG. 3), which is out of contact with the bellows 5, on an inner surface of the large-diameter annular portion 6 and has the annular recess 6A in that part of the inner circumference of the above-mentioned boot band-free zone 6C which is adjacent to the bellows 5. This allows the boot 1 to increase flexibleness of that bottom 4F of the bellows 5 which is closest to the large-diameter annular portion 6. In this way, by being equipped with the annular recess 6A, the constant velocity universal joint boot 1 according to the present invention dramatically improves flexibility when the constant velocity universal joint swings and can alleviate stress produced by deformation of the bellows 5. Furthermore, it becomes possible to widen an operating angle of the constant velocity universal joint and increase service life of the boot 1.

Furthermore, as shown in FIG. 3, preferably a thickness (t1) of the boot band-free zone 6C in the constant velocity universal joint boot 1 according to the present invention is larger than a thickness (t2) of that bottom of the bellows 5 which is closest to the boot band-free zone 6C, and is two times or less the thickness (t2) of the bottom. A reason for this is that this can alleviate stress concentration on the boot band-free zone 6C of the boot 1 resulting from widening of the operating angle of the constant velocity universal joint and further increases the service life of the boot 1 as well as prevent breakage of the boot band-free zone 6C due to an external factor such as a flying stone. Here, it is undesirable that t1≤t2 because then if stresses are applied repeatedly to the boot 1, durability of the boot band-free zone 6C decreases, making it impossible to achieve a long service life. Also, it is undesirable that t1≥2t2 because this will greatly reduce the flexibility of boot 1.

(2) Small-Diameter Annular Portion

All the technical concepts applied to the small-diameter annular portion of the conventional tripod joint boot are applicable to the small-diameter annular portion 2 of the constant velocity universal joint boot 1 according to the present invention. Generally, the small-diameter annular portion 2 has an annular shape in order to be fixed by being fitted around a shaft portion (output drive shaft 20) of the tripod joint boot. Then, to ensure sealing between the output drive shaft 20 and small-diameter annular portion 2, the boot band-attaching zone (not shown) fastened and fixed by the boot band (not shown) is provided on outer circumferential part of the small-diameter annular portion 2. This is intended to prevent grease enclosed in the tripod joint from leaking out between the small-diameter annular portion 2 and output drive shaft 20.

(3) Bellows

All the technical concepts applied to the bellows of the conventional constant velocity universal joint boot are applicable to the bellows 5 of the constant velocity universal joint boot 1 according to the present invention, and there is no particular restriction. Generally, the bellows 5 are provided with crests (outwardly-projecting portions of the boot 1) 3A to 3F and bottoms (inwardly-depressed portions of the boot 1) 4A to 4F, which alternate successively, and is connected between the small-diameter annular portion 2 and large-diameter annular portion 6. The bellows 5, which display pliability and have buffering effects, do not hinder swinging of the tripod joint and play the role of protecting a coupling (not shown) of constant velocity universal joint from flying objects such as flying stones.

Note that as shown in FIG. 4, the bellows 5 of the constant velocity universal joint boot 1 according to the present invention, are formed into the shape of a substantially truncated cone with the crests 3A to 3F and bottoms 4A to 4F changing gradually in outside diameter from one end to the other end. By adopting this structure, capability of the boot 1 to follow behavior of the tripod joint can be ensured. However, when the boot 1 is used for automobiles, the shape of the boot 1 is not limited to the one shown in FIG. 4, and opposite ends of the boot 1 may be made almost equal in outside diameter or the numbers of crests and bottoms may be changed as appropriate by taking the size, wall thickness, and the like of the boot 1 into consideration.

B. Manufacturing Form of the Constant Velocity Universal Joint Boot According to the Present Invention

(1) Basic Configuration of the Constant Velocity Universal Joint Boot According to the Present Invention

In the constant velocity universal joint boot 1 according to the present invention, the large-diameter annular portion 6 (excluding the annular thick-walled portion 6B), small-diameter annular portion 2, and bellows 5 described above are molded integrally. If the small-diameter annular portion 2, bellows 5, and large-diameter annular portion 6 (excluding the annular thick-walled portion 6B) are formed separately and joined together subsequently, when stresses concentrate on the junction, the junction is prone to cracking, separation, and the like. This makes it impossible to increase the service life of the boot 1, causes the grease enclosed in the constant velocity universal joint to leak out of the boot 1, and so on, and thus is undesirable.

(2) Available Constituent Materials

It is sufficient if a constituent material used in forming a primary molded member 10 of the constant velocity universal joint boot 1 according to the present invention is a thermoplastic resin, and there is no other particular restriction. As the thermoplastic resin, preferably, for example, polyethylene, polypropylene, polyvinyl chloride, polyvinylidene chloride, polystyrene, polyurethane, polytetrafluoroethylene, ABS resin, acrylic resin. or the like is adopted. A reason for this is that these materials excel in terms of cost and ease of handling during manufacturing as well as in terms of flexibility after cure and promise a longer service life of the boot 1.

On the other hand, regarding the constituent material used in forming a secondary molding 6B, the same constituent material as the primary molded member 10 is preferably adopted. A reason for this is that this enables easy compatibilization in an interface between the primary molded member 10 once cured and the secondary molding 6B, making it easy to integrate the two. However, it is not always necessary to use the same material for the primary molded member 10 and secondary molding 6B, and different materials may be used according to required quality as long as excellent compatibility may be adopted as described above.

(3) Concrete Manufacturing Method

In forming the primary molded member 10 and secondary molding 6B described above, publicly known molding methods such as press blow molding, extrusion blow molding, injection blow molding, and injection molding are available for use. Consequently, almost all manufacturing methods disclosed in Patent Literature 2 described above can be adopted (Note that a patent application for the invention disclosed in Patent Literature 2 was filed by the applicants of the present invention in the past). Thus, because fundamental concepts of the manufacturing method for the constant velocity universal joint boot 1 according to the present invention has already been widely known among those skilled in the art from Patent Literature 2, only one example will be shown below and detailed description thereof will be omitted. For example, the constant velocity universal joint boot 1 according to the present embodiment can be formed using the following procedures.

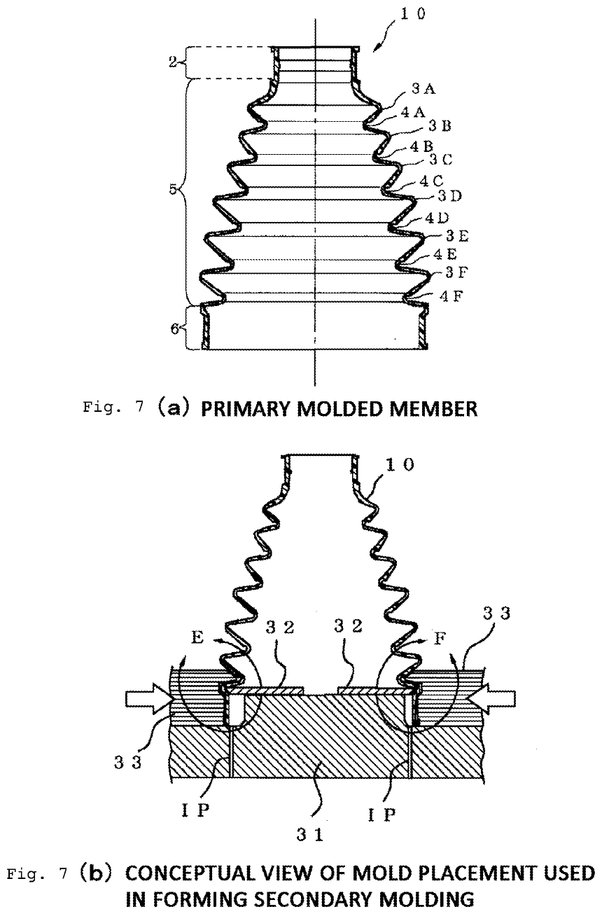

Forming the primary molded member: Using a publicly known press blow molding method also disclosed in Patent Literature 2 described above, a melted material (e.g., thermoplastic resin such as a polyethylene-based resin) is extruded into a mold. Subsequently, the extruded resin material is sandwiched in the mold, and then air is blown in, bringing the resin material into close contact with the mold, to obtain the primary molded member 10 (see FIG. 7(a)) made up of the small-diameter annular portion 2, bellows 5, and large-diameter annular portion 6 connected integrally in a row.

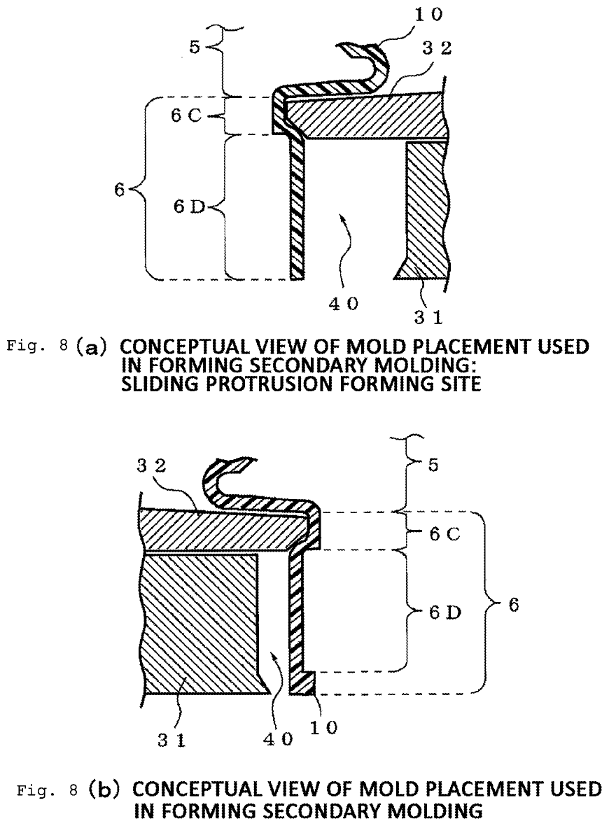

Forming the secondary molding: The primary molded member 10 thus obtained is placed in a stationary mold 31 as shown in the sectional view of FIG. 7(b). Then, a movable mold 32 for use to form the annular recess 6A is placed on a top face of the stationary mold 31. Furthermore, a split mold 33 for use to form a secondary molding space 40 (see FIG. 8) is placed on an outer circumference of the primary molded member 10 placed in the stationary mold 31. By adopting this mold placement, a desired molten material (e.g., thermoplastic resin such as a polyethylene-based resin) is injected into the secondary molding space 40 through an injection hole using an injection method, and then the above-mentioned secondary molding 6B (see FIG. 3) with a different wall thickness is provided only on an inner circumferential portion of the boot band-attaching zone 6D of the large-diameter annular portion 6 of the primary molded member 10 and integrated therewith.

Using enlarged schematic diagrams (see FIG. 8) of region E and region F shown in FIG. 7(b), formation of the secondary molding 6B of the constant velocity universal joint boot 1 according to the present invention will be described in more detail. As shown in FIG. 8, the stationary mold 31 and movable mold 32 are placed inside the primary molded member 10. Then, the movable mold 32 is moved to such a position as to come into contact with an inner surface of the boot band-free zone 6C of the primary molded member 10. Subsequently, the secondary molding space 40 for use to form the secondary molding 6B (including the projections 30 in FIG. 3(a); see FIG. 3), is formed by the stationary mold 31 and movable mold 32 in conjunction with the inner circumferential surface of the large-diameter annular portion 6 of the primary molded member 10. Then, as molten material is injected into the secondary molding space 40, the inner circumferential surface provided with the annular thick-walled portion 6B is formed in the large-diameter annular portion 6. Subsequently, when the movable mold 32 is moved and pulled out, the constant velocity universal joint boot 1 according to the present invention is obtained.

Whereas a method for integrating the secondary molding 6B and the primary molded member 10 in a mold has been described above in the manufacturing method for the boot, the manufacturing method for the constant velocity universal joint boot 1 according to the present invention is not limited to the manufacturing method described above. For example, the effects of the present invention can also be obtained by manufacturing the secondary molding 6B separately from the primary molded member 10 and joining the secondary molding 6B to the primary molded member 10, thereby forming the annular recess 6A.

Description will be given below using an example of the present invention and a comparative example. Note that the present invention is not to be interpreted as being limited by these examples.

### Example

The constant velocity universal joint boot 1 according to the present example (hereinafter referred to as the “example boot”) is the tripod joint boot shown in FIG. 1. The example boot is produced by the method described above (see FIG. 7(a), FIG. 7(b), FIG. 8(a), and FIG. 8(b)). Thus, redundant description will be omitted. Data on the example boot is listed below.

### [Data on Example Boot]

Total length: 107 mm

Total length (excluding boot band-attaching zone): 94 mm

Boot wall thickness of boot band-free zone: 1.3 mm Outside diameter of small-diameter annular portion: 29.7 mm

Outside diameter of large-diameter annular portion: 79.4 mm

Numbers of crests and bottoms in bellows: 6 each

Average wall thickness: 1.05 mm

### Comparative Example

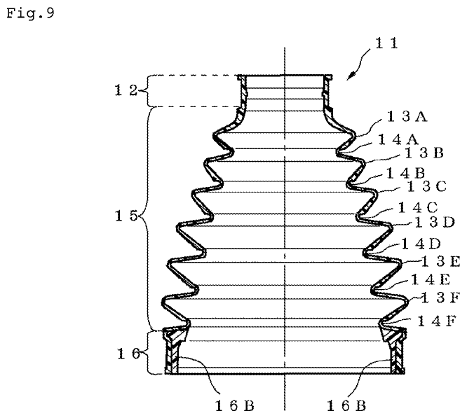

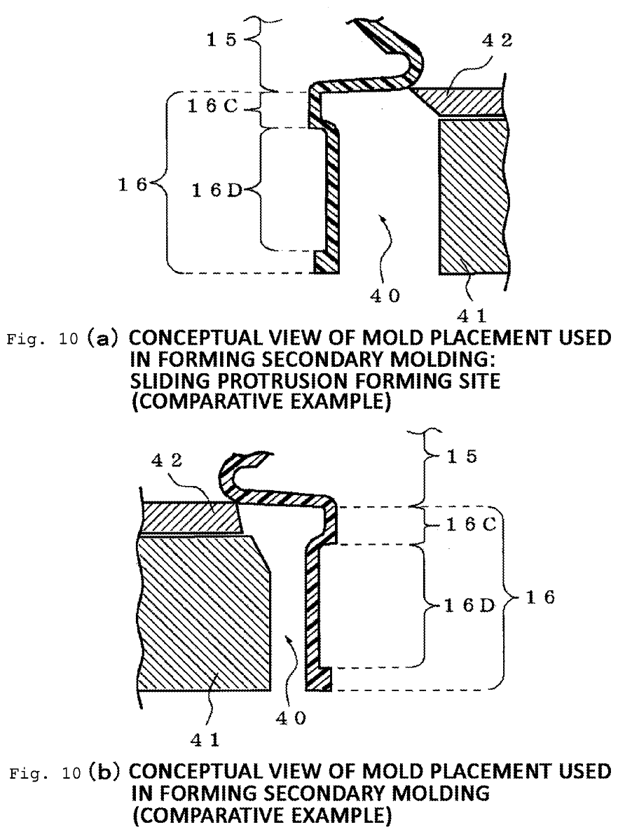

The constant velocity universal joint boot produced in the comparative example is the tripod joint boot 11 (see FIG. 9; hereinafter referred to as the “comparative boot”) that can be compared with the example. As shown in the sectional view of FIG. 9, in the comparative boot, the large-diameter annular portion 16 has an annular thick-walled portion 16B in contact with the bellows 15, on an inner surface of the large-diameter annular portion 16, and inner circumferential part of a boot band-free zone 16C (see FIG. 10) lacks an annular recess.

The comparative boot was produced by the method disclosed in Patent Literature 2. Specifically, in producing the comparative boot, a secondary molding (annular thick-walled portion 16B) was molded integrally with an inner circumferential surface of the large-diameter annular portion 16 by placing a stationary mold 41 and movable mold 42 as shown in FIG. 10, and the other parts were produced by the same method as the example. That is, in the comparative boot, secondary molding (annular thick-walled portion 16B) was formed in part of the bellows as well. Note that “data on the comparative boot” was the same as the example boot except that the boot wall thickness of the boot band-free zone was 7.1 mm.

### [Comparison Between Example Boot and Comparative Boot]

FIG. 6 shows a bent state of the example boot with the operating angle θ of the tripod joint set to 15° when the example boot is used. FIG. 5 shows a bent state of the comparative boot with the operating angle θ of the tripod joint set to 15° when the comparative boot is used. Note that in FIGS. 5 and 6, the alternate long and short dash line indicated by reference sign X represents the position of a tripod joint shaft portion 20 when the operating angle θ of the tripod joint is 0°. Then, using a non-linear stress analysis simulation (analytical software: Marc/Mentat (registered trademark)), stress applied to the bellows 5 at an operation angle θ of 15° was found. That is, compressive stress on the bottoms 4A to 4F (example) and 14A to 14F (comparative example) of the bellows 5 (example) and 15 (comparative example) located in the operating direction of the shaft portion 20 of the tripod joint was found.

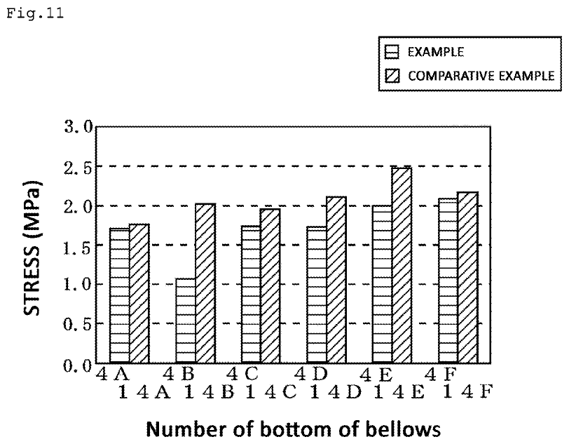

FIG. 11 shows non-linear stress analysis simulation results (stress acting on the bottoms in the boot when the operating angle of the tripod joints was changed) of the example and comparative example. As shown in FIG. 11, it can be seen that the stress on the bottoms 4B of the bellows 5 of the example boot is far lower than the stress on the bottoms 14B of the bellows 15 of the comparative boot. A reason for this is that as shown in FIG. 5 and FIG. 6, with the formation of the annular recess 6A in the example boot, a region in which bottoms (e.g., 4F) of the bellows can move is increased (bottoms 4F to 4C in FIG. 6 are bent greatly downward in the figure), alleviating stress concentration on the bottom 4B.

Furthermore, as shown in FIG. 11, stress applied to the bottoms 4A to 4F of the bellows 5 of the example boot is reduced as a whole compared to the comparative boot. In particular, whereas the highest stress applied to the comparative boot, i.e., the stress applied to the bottom 14E, is 2.5 MPa, in the case of the example boot, the stress applied to the bottom 4E is reduced to 2.0 MPa. In this way, by adopting the circumferential surface geometry prescribed in the present invention for the constant velocity universal joint boot 1 of the large-diameter annular portion 6, it is possible to increase flexibleness of the bellows 5, contributing to improvement of resistance to fatigue failure.

### INDUSTRIAL APPLICABILITY

By being equipped with the annular recess in that part of the inner circumferential surface of the large-diameter annular portion which is adjacent to the bellows, the constant velocity universal joint boot according to the present invention is less prone to deformation stress of the bellows regardless of behavior (swinging, sliding) of the constant velocity universal joint and is provided with excellent flexibility, and thus has extremely high industrial utility value.

### REFERENCE SIGNS LIST

1 Constant velocity universal joint boot (boot)
2 Small-diameter annular portion
3A to 3F Crest (bellows)
4A to 4F bottom (bellows)
5 Bellows
6 Large-diameter annular portion
6A Annular recess
6B Annular thick-walled portion (secondary molding)
6C Boot band-free zone
6D Boot band-attaching zone
10 Primary molded member
20 Shaft portion (output drive shaft)
30 Projection
40 Secondary molding space
P Axial direction
X Zero-degrees operating angle line
θ Operating angle

1. A constant velocity universal joint boot, wherein:
a large-diameter annular portion mounted on a mating member whose outer circumferential surface is formed into a non-circular shape, and at least a part of the inner circumferential surface of the large-diameter annular portion formed into a non-circular shape, and the large-diameter annular portion, a boot bellows portion, and a small-diameter annular portion attached to a shaft are integrated,
and
an annular recess is provided in that part of the inner circumferential surface of the large-diameter annular portion which is adjacent to the bellows.

2. The constant velocity universal joint boot according to claim 1, wherein the large-diameter annular portion includes a boot band-free zone and a boot band-attaching zone in sequence starting from a bellows side, the boot band-free zone being not fastened and fixed by a boot band, the boot band-attaching zone being fastened and fixed by a boot band; and an annular thick-walled portion is provided on at least a part of the inner circumferential surface of the large-diameter annular portion corresponding to the boot band-attaching zone, and an annular recess portion is provided on the large-diameter annular portion inner circumferential surface of the boot band band-free zone.

3. The constant velocity universal joint boot according to claim 2, wherein the annular thick-walled portion provided on the inner circumferential surface of the large-diameter annular portion corresponding to the boot band-attaching zone includes a primary molded member made up of the small-diameter annular portion, the bellows, and the large-diameter annular portion molded integrally, and a secondary molding provided only on the inner circumferential surface of the large-diameter annular portion of the primary molded member.

4. The constant velocity universal joint boot according to any one of claim 2, wherein a thickness (t1) of the annular thick-walled portion provided on the inner circumferential surface of the large-diameter annular portion corresponding to the boot band-free zone is larger than a thickness (t2) of that bottom of the bellows which is closest to the boot band-free zone, and is two times or less the thickness (t2) of the bottom.

5. The constant velocity universal joint boot according to any one of claim 2, wherein the annular thick-walled portion provided on the inner circumferential surface of the large-diameter annular portion corresponding to the boot band-attaching zone has a fine annular protrusion on a surface thereof.

6. The constant velocity universal joint boot according to claim 1, wherein the constant velocity universal joint is a tripod joint.

7. The constant velocity universal joint boot according to any one of claim 3, wherein a thickness (t1) of the annular thick-walled portion provided on the inner circumferential surface of the large-diameter annular portion corresponding to the boot band-free zone is larger than a thickness (t2) of that bottom of the bellows which is closest to the boot band-free zone, and is two times or less the thickness (t2) of the bottom.

8. The constant velocity universal joint boot according to any one of claim 3, wherein the annular thick-walled portion provided on the inner circumferential surface of the large-diameter annular portion corresponding to the boot band-attaching zone has a fine annular protrusion on a surface thereof.
